(19) United States
(12) Patent Application Publication
(10) Pub. No.: US 2008/0153372 A1
(43) Pub. Date: Jun. 26, 2008

(54) Insect-Repellant Fabrics and Methods for Making Them

(75) Inventors: Rembert Joseph Truesdale, Thomaston, GA (US); Phillip H. Riggins, Greensboro, NC (US)

Correspondence Address: JOHN S. PRATT, ESQ;KILPATRICK STOCKTON, LLP, 1100 PEACHTREE STREET, ATLANTA, GA, 30309, US

(73) Assignee: Southern Mills, Union City, GA (US)

(21) Appl. No.: 11/960,894

(22) Filed: Dec. 20, 2007

Related U.S. Application Data
(63) Continuation-in-part of application No. 11/407,649, filed on Apr. 20, 2006.
(60) Provisional application No. 60/877,719, filed on Dec. 29, 2006.

(51) Int. Cl. B32B 5/02; B05D 3/00

(52) U.S. Cl. 442/125; 427/372.2

(57) ABSTRACT

Insect repellant fabrics which also have flame retardant properties are disclosed. The fabrics have insect repellant molecules absorbed in the fibers of the fabrics. The fabrics retain their insect repellant and flame retardant properties after laundering. The fabrics are suitable for use in clothing and, more particularly, are suitable for use in protective garments designed to be worn by individuals, such as industrial workers, military and rescue personnel, and firefighters, who may be at risk of exposure to both fire and disease carrying insects. The insect repellant molecules may be incorporated into the fabrics in a variety of ways including, but not limited to, immersing the fibers or fabrics in a bath containing an insect repellant and heating the bath.

### CROSS REFERENCE TO RELATED APPLICATIONS

This application claims the benefit of U.S. Provisional Application No. 60/877,719, filed Dec. 29, 2006 and is a continuation-in-part of U.S. patent application Ser. No. 11/407,649, filed Apr. 20, 2006, and entitled “Ultraviolet-Resistant Fabrics and Methods for Making Them.”

### BACKGROUND

Many occupations (including, but not limited to, industrial (e.g., utility workers, petrochemical workers, etc.), military, rescue, firefighting, construction, and landscaping) require that time be spent in outdoor environments. In many instances, these environments are populated by a variety of insects. Many of these insects, such as mosquitoes and ticks, can bite, sting, or otherwise make undesirable contact with people. Although some insects are merely a nuisance, other insects can carry diseases, viruses, or other maladies that may be transmitted through biting or other contact with the person. For example, mosquitoes have been known to carry the West Nile virus, malaria, yellow fever, dengue fever, encephalitis, and other maladies. In addition, ticks can carry Lyme disease. Other insects can carry other serious diseases or maladies, and have been known to bite humans or otherwise transmit such diseases through biting or other types of contact.

Insect bites can sometimes be avoided by staying indoors or avoiding certain geographical areas. These alternatives may not always be available, however, when the person is required by their job duties to spend extended periods of time outdoors. In these cases, a person can reduce the possibility or frequency of insect bites by applying a topical insect repellent to his or her skin. Although topical insect repellents can reduce the likelihood or frequency of insect bites, insects may still bite the person through a garment, such as a shirt or relatively thin jacket, that is being worn on the person's body.

Sometimes people's occupations not only require them to spend time in outside environments, but also expose them to the threat of fire. For example, industrial workers, military and rescue personnel, and firefighters all work in outside environments that can expose them to flames and other heat sources. In these cases, it may be desirable to provide an insect repellent garment that is flame resistant or flame retardant. It is conceivable to impart insect repellent properties to a flame resistant garment by spraying a commercial insect repellant onto the otherwise flame resistant material. This method of treatment, however, causes the treated garment to burn because the applied insect repellant impairs the material's flame resistant properties. Moreover, the insect repellant washes off the garment after the garment has been laundered or worn for an amount of time. It is therefore desirable to provide a garment having both flame resistant and insect repellant properties, whereby the insect repellency does not impair the flame resistance, and the garment does not lose effectiveness of either property upon laundering of the garment.

In view of the above, it would be desirable to produce garments that repel insects.

It would also be desirable to produce garments with both insect repellant and flame retardant or flame resistant properties.

It would also be desirable to produce garments that can be laundered without losing their insect repellant and flame retardant or flame resistant properties.

### SUMMARY OF THE INVENTION

The above mentioned objectives are accomplished by embodiments of the present invention. One embodiment comprises fabrics treated with at least one insect repellant, wherein the insect repellant is absorbed, imbibed, or otherwise taken into and locked in the fibers. Over time, the insect repellent molecules are slowly released to the surface of the fibers where they act as a repellent to insects. While these fabrics repel insects, they can be laundered without losing their insect repellant properties.

In another embodiment, the fabrics treated with at least one insect repellant further comprise at least some fibers having flame resistant properties. These fabrics repel insects while maintaining their flame resistant properties and can be laundered without losing their insect repellant or flame resistant properties.

Another embodiment of the invention comprises a method for imparting insect repellant properties to fabrics such that the fabrics maintain their insect repellant properties after laundering.

### DETAILED DESCRIPTION OF THE INVENTION

In one embodiment of the invention, a garment can comprise a shirt that can be worn by a user in environments where the user may encounter one or more disease-bearing insects. The shirt is made of material that, as described below, is treated with at least one insect repellent. Although a shirt is described for purposes of example, other types of garments may benefit from the fabrics and methods described herein. Such garments may include, but are not limited to, one or more of jackets, pants, coveralls, vests, and the like that are intended for use in various applications. Moreover, the present disclosure is not limited to garments. More generally, the present disclosure pertains to any fabric where insect repellency is desirable. For example, insect repellency is desirable in fabrics used in curtains that hang over windows or doors, canopies that drape over beds or other sleeping accommodations, or fabrics used to make tents or other flexible shelters.

In other embodiments of the invention, the garment can be constructed from a fabric having flame resistant properties. Such fabric may comprise inherently flame resistant fibers, fibers that are not inherently flame resistant but that, as fibers or yarns, have been treated with flame retardant chemicals, or both types of fibers. As used herein, “inherently flame resistant fibers” refers to fibers that do not burn because the chemical structure of the fiber is extremely stable. Examples of inherently flame resistant fibers include, but are not limited to, aramid (aromatic polyamide), polybenzoxazole (PBO), polybenzimidazole (PBI), melamine, polyamide, polyimide, polyimideamide, and modacrylic fibers. Examples of non-inherently flame resistant fibers that may be treated with flame retardant chemicals include, but are not limited to, cellulosic fibers such as rayon, acetate, triacetate, and lyocell. It is to be understood that these constructions are mere examples and are not intended to limit the scope of the present disclosure.

Regardless of the types of fibers from which the fabric is constructed, it is preferable that the insect repellent be absorbed, imbibed or otherwise taken in by at least some of the fibers (rather than merely applied to the surface of the fibers). In this way, the insect repellency properties of the fabric are better retained after repeated launderings.

Insect repellency may be imparted to the fabric (which is preferably, but not necessarily, also flame resistant) in a variety of ways. In one embodiment, the insect repellent is added to the fabric during a dyeing process or during a finishing process. In one embodiment, the fabric can be treated with insect repellant in a dye-bath wherein several ingredients are mixed together in liquid form, and the fabric is immersed in the dye-bath. Examples of ingredients in the dye-bath could include any or all of: dye to color the fabric, a dye assistant (or “carrier”), an insect repellant, or a flame retardant additive (if applicable). Carriers aid in the absorption of dye into the fibers of the fabric. In some cases, the carrier may act as a natural insect repellant, as discussed below. Example carriers include dibutylacetamide, dibutylformamide, aryl ether, isophorone, benzyl alcohol, N-cyclohexyl pyrrolidinone (CHP), and N-diethyl-m-toluamide (“DEET”). Example insect repellents include, but are not limited to, permethrin (such as Evercide 2778 available from McLaughlin Gormley King Co. or Permanone 40 available from Bayer Environmental Science) and DEET (available from Fisher Scientific and from Morflex, Inc.).

Once the dye-bath is formed, the fabric is contacted with the dye-bath, typically by immersion, and the dye-bath is heated to fix the dye in the fibers. During this process, the insect repellent, which can be in the form of the carrier or a separate chemical, is absorbed, imbibed or otherwise taken in by at least some of the fibers. Over time, the insect repellent molecules are slowly released to the surface of the fibers where they act as a repellent to insects. It will be obvious to one of ordinary skill in the art that dyeing need not occur during this process. Rather, the process may be carried out without a dye if it is desired to impart insect repellent properties to already-dyed or un-dyed fabrics.

Although the fabric has been described as being treated with an insect repellant, a flame retardant, or a combination thereof when the fabric is wholly constructed, the treatment can be performed during earlier stages of the process such as on the fibers, yarn, or other fibrous textile before it is woven or spun into wholly constructed fabric. Additionally, a carrier can be imbibed into the fibers during fiber production prior to treating the fibers or the fabric constructed therefrom. This method may be advantageous in that additional carrier may not be needed in the bath. Equipment for dyeing textiles includes jig dyeing machines, pad dyeing machines, beck dyeing machines, and jet dyeing machines.

One type of insect repellant is permethrin, which can be added to the dye-bath in a concentration that ranges from about 0.15% on weight of fabric (“owf”) to about 2.80% owf During the dye-bath process, a carrier may be, but need not always be, used to solubilize the permethrin such that the permethrin may be absorbed into the fibers of the fabric more readily. The bath may be conducted at temperatures ranging from about 100° F. to about 300° F. When the bath is conducted below the boiling point, which is 212° F. at atmospheric pressure, CHP or benzyl alcohol may be particularly effective in achieving insect repellant absorption. After the fabric has been treated in the bath, it is removed and heated to dry the fabric. When the fabric dries, the fibers contract and lock the insect repellant molecules in the fiber, which allows the insect repellant to remain in the garment even after the garment has been laundered. With such concentrations, after approximately 20 launderings residual levels of permethrin are about 0.10-1.75% owf. Table I shows two specific examples of fabrics dyed in dyebaths containing permethrin. Fabric 1 is a 4.0 ounce per square yard (osy), 65/35 blend of Nomex T-462 and FR rayon, plain weave fabric, and Fabric 2 is a 6 osy, Nomex T-462, plain weave fabric.

TABLE I

| | % permethrin owf | % permethrin owf | % permethrin owf |
|---|---|---|---|
| Fabric | after treatment | after 10 launderings | after 20 launderings |
| Fabric 1 | 0.70 | 0.55 | 0.51 |
| Fabric 2 | 0.41 | 0.41 | 0.39 |

Amounts of insect repellant on the fabric were determined using gas chromatography, such as the GLC Method of Analysis for Permethrin in Technical Material and Formulations available from the McLaughlin Gormley King Company.

As an example, one possible test method for determining the amount of permethrin incorporated into the fabric uses a gas chromatograph equipped with a flame ionization detector. The column is 5% OV-1 on Chromosorb W(HP) 80/100 mesh, 120 cm×4 mm i.d., glass. The column temperature is 250° C., and the injection port and detector temperatures are each 300° C. Gas flows are N₂ at 50 mls/min, air at 240 mls/min, and H₂ at 60 mls/min. The flame ionization detector has a sensitivity of 5×10⁻¹¹ AFS. The method is as follows: A sample of permethrin in acetone is prepared such that the amount of permethrin in the acetone is approximately 1.0 mg/ml. A standard solution comprising 1.0 mg/ml of permethrin in acetone is also prepared. The sample and standard solution each further comprise one equivalent of diethylhexyl phthalate as an internal standard. The sample and standard solutions are injected onto the column. Retention time is about 5 minutes for permethrin and about 3 minutes for diethylhexyl phthalate. This method does not separate the isomers of permethrin.

In an alternate embodiment, the insect repellant, such as permethrin, is incorporated into the fabric during a finishing process. The finishing process can occur alternatively or in addition to treating the fabric with an insect repellant in a dye-bath. One such finish formulation can contain 0.9%-6.0% on weight of bath (“owb”), 40% active permethrin. The finish can be applied by a finish applicator such as a Pad Roll, Kiss Roll, Knife-over roll, or foam finish applicator. The treated fabric can be dried in a drying oven (or tenter) at around 250° F.-400° F. for a time sufficient to dry the fabric. When the fabric dries, the fibers contract and lock the insect repellant in the fiber. In an alternate embodiment, binders such as melamine formaldehyde resins, dimethyloldihydroxyethyleneurea (DMDHEU) resins, acrylic polymers, polyurethane polymers, etc. may be added to the finishing formula to assist in maintaining laundering durability.

In addition to permethrin, another insect repellant that may be used is N-diethyl-m-toluamide (“DEET”). As mentioned above, DEET can also serve as a carrier during the dyeing process. Traditionally, carriers are removed as much as possible from the dyed fabric because of the flammability of the carriers. However, where DEET is used as an insect repellant and is incorporated in the fabric using the dye-bath method, relatively large amounts of DEET can be used so that a relatively high residual amount of DEET remains in the fibers after the bath is completed. The DEET may be added to the dye-bath in a concentration that ranges from about 10 grams per liter (gpL) to about 60 gpL. With such concentrations, residual levels of DEET of about 0.10%-1.75% owf can be achieved. Alternatively or in addition, DEET can be incorporated into the fibers during a finishing process in a manner similar to that described above in relation to permethrin. In such a case, the finishing formula can include DEET in a concentration of about 0.9%-6.0% owb.

A flame retardant compound can also be included in the dye-bath, applied as a finishing treatment, or otherwise incorporated into the fibers of the fabric to enhance flame resistance or to counteract any deleterious effects of the carrier contained within the fibers. Furthermore, other chemicals can be applied to the fibers (e.g., added to the mixture) including lubricants, wetting agents, leveling agents, and the like. Incorporating flame retardant compound in the fiber matrix may also enhance durability of the fibers and resulting products.

Embodiments of this invention were tested by Insect Control & Research of Baltimore, Md. in order to determine the insect repellent properties of the fabric. The test method used fabric samples treated with both permethrin and DEET, and further tested the samples both before and after laundering. The fabric was wrapped around a tube constructed of a screen of the type typically used as a window screen. Fabric that was not treated with any insect repellant was wrapped around another tube to serve as the control tube. Volunteers then placed their arms in the tubes, and placed their arms into cages containing 250 mosquitoes. The number of mosquitoes on the fabric was counted after three minutes. Thereafter, the number of mosquitoes was counted at thirty-minute intervals until the fabric no longer repelled mosquitoes. The repellency of the fabric was calculated using the following equation: R=(C−T)/C*100, wherein R is repellency, C is the number of mosquitos that landed on the control fabric and T is the number of mosquitos that landed on the impregnated fabric.

Table II shows the test results for a 4.5 ounce per square yard (osy), 65/35 blend of Nomex T-462® and FR rayon (Fabric A) treated with 1.6% owf of permethrin. The fabric was tested both before and after laundering. As can be appreciated from Table II, markedly improved results were achieved with the unlaundered, treated fabric as compared to the unlaundered, untreated fabric, with an average repellency increase of about 75% over an eight-hour time period. Similarly, improved results occurred for the laundered, treated fabric as compared to the laundered, untreated fabric, with an average repellency increase of about 38% over a period of approximately two hours.

TABLE II

| | | | Number | |
|---|---|---|---|---|
| | Number of | Number | Mosquitoes | Repellency |
| Exposure | Laundry | Mosquitoes | on Treated | Increase |
| Time (Hrs.) | Cycles | on Control Fabric | Fabric A | (%) |
| 0.5 | 0 | 102 | 6 | 94.1 |
| 1.0 | 0 | 80 | 5 | 93.8 |
| 1.5 | 0 | 47 | 5 | 89.4 |
| 2.0 | 0 | 26 | 7 | 73.1 |
| 2.5 | 0 | 16 | 3 | 81.3 |
| 3.0 | 0 | 91 | 19 | 79.1 |
| 3.5 | 0 | 49 | 10 | 79.6 |
| 4.0 | 0 | 51 | 11 | 78.4 |
| 4.5 | 0 | 37 | 10 | 73.0 |
| 5.0 | 0 | 32 | 13 | 59.4 |
| 5.5 | 0 | 41 | 11 | 73.2 |
| 6.0 | 0 | 24 | 11 | 54.2 |
| 6.5 | 0 | 44 | 15 | 65.9 |
| 7.0 | 0 | 49 | 12 | 75.5 |
| 7.5 | 0 | 46 | 15 | 67.4 |
| 8.0 | 0 | 26 | 12 | 53.8 |
| 0.5 | 20 | 15 | 7 | 53.3 |
| 1.0 | 20 | 31 | 12 | 61.3 |
| 1.5 | 20 | 19 | 17 | 10.5 |
| 2.0 | 20 | 34 | 25 | 26.5 |

Turning to Table III, a 4.5 osy, 65/35 blend of Nomex T-462® and FR rayon (Fabric B) was treated with 24% owf of DEET. A sample of the treated fabric and an untreated sample (i.e., “control”) of the same fabric were tested in the same manner described above. As can be appreciated from Table III, markedly improved results were for the most part achieved with the unlaundered, treated fabric as compared to the unlaundered, untreated fabric, with an average repellency increase of about 46% over a two hour time period. Similarly, improved results occurred for the laundered, treated fabric as compared to the laundered, untreated fabric, with an average repellency increase of about 64% over a period of approximately two hours.

TABLE III

| | | | Number | |
|---|---|---|---|---|
| | Number of | Number | Mosquitoes | |
| Exposure | Laundry | Mosquitoes on | on Treated | Repellency |
| Time (Hrs.) | Cycles | Control Fabric | Fabric B | Increase (%) |
| 0.5 | 0 | 43 | 6 | 86.0 |
| 1.0 | 0 | 24 | 25 | −4.2 |
| 1.5 | 0 | 45 | 20 | 55.6 |
| 2.0 | 0 | 36 | 19 | 47.2 |
| 0.5 | 20 | 52 | 3 | 94.2 |
| 1.0 | 20 | 37 | 14 | 62.2 |
| 1.5 | 20 | 38 | 16 | 57.9 |
| 2.0 | 20 | 30 | 17 | 43.3 |

While particular embodiments of insect-repellant fabrics for protective garments have been disclosed in detail in the foregoing description and drawings for purposes of example, it will be understood by those skilled in the art that variations and modifications thereof can be made without departing from the scope of the disclosure.

The invention claimed is:

1. A fabric comprising:
(a) a plurality of fibers; and
(b) insect repellant molecules absorbed within at least some of the plurality of fibers.

2. The fabric of claim 1, wherein at least some of the plurality of fibers comprise flame resistant fibers.

3. The fabric of claim 2, wherein the flame resistant fibers comprise at least one of aramid fibers, polybenzoxazole fibers, polybenzimidazole fibers, melamine fibers, polyimide fibers, or polyimideamide fibers.

4. The fabric of claim 3, wherein the flame resistant fibers comprise at least one of para-aramid fibers or meta-aramid fibers.

5. The fabric of claim 2, wherein the flame resistant fibers comprise cellulosic fibers that have been treated with a flame retarding compound.

6. The fabric of claim 1, wherein the insect repellant molecules comprise at least one of permethrin or N-diethyl-m-toluamide.

7. A garment constructed from the fabric of claim 1.

8. A flame resistant fabric comprising:
(a) a plurality of fibers, wherein at least some of the plurality of fibers comprise flame resistant fibers; and
(b) insect repellant molecules absorbed within at least some of the plurality of fibers, wherein the insect repellant molecules comprise at least one of permethrin or N-diethyl-m-toluamide.

9. The fabric of claim 8, wherein the flame resistant fibers comprise at least one of aramid fibers, polybenzoxazole fibers, polybenzimidazole fibers, melamine fibers, polyimide fibers, or polyimideamide fibers.

10. The fabric of claim 9, wherein the flame resistant fibers comprise at least one of para-aramid fibers or meta-aramid fibers.

11. The fabric of claim 8, wherein the flame resistant fibers comprise cellulosic fibers that have been treated with a flame retarding compound.

12. A garment comprising the fabric of claim 8.

13. A process of treating fibers with an insect repellant comprising:
(a) immersing the fibers in a solution comprising a plurality of insect repellant molecules;
(b) heating the solution;
(c) removing the fibers from the solution; and
(d) drying the fibers,
wherein at least some of the plurality of insect repellant molecules are absorbed within at least some of the fibers.

14. The process of claim 13, wherein the solution further comprises at least one of a dye, a carrier, or a flame retardant compound.

15. The process of claim 13, wherein at least some of the fibers comprise flame resistant fibers.

16. The process of claim 13, wherein the insect repellant molecules comprise at least one of N-diethyl-m-toluamide or permethrin.

17. The process of claim 13, wherein the solution is heated to a temperature of between about 100° F. and about 300° F.

18. The process of claim 13, wherein immersing the fibers in a solution comprises immersing at least a portion of a fabric comprising the fibers in the solution.
